(19) United States
(12) Patent Application Publication
(10) Pub. No.: US 2026/0147531 A1
(43) Pub. Date: May 28, 2026

(54) IN-VEHICLE APPARATUS

(71) Applicant: SUBARU CORPORATION, Tokyo (JP)

(72) Inventor: Yutaka HIOKI, Tokyo (JP)

(21) Appl. No.: 19/118,809

(22) PCT Filed: Sep. 29, 2023
(86) PCT No.: PCT/JP2023/035687

§ 371 Date: Apr. 7, 2025

(51) Int. Cl. G06F 3/16; B62D 1/04; G07C 5/02

(52) U.S. Cl. CPC G06F 3/165; B62D 1/046; G07C 5/02

(57) ABSTRACT

An in-vehicle apparatus according to an embodiment of the disclosure includes: a storage circuit configured to store pieces of reference audio data indicating sounds that are likely to be a hindrance to a driving operation of a driver; and a processing circuit configured to compare audio data included in a content with each of the pieces of reference audio data and perform a determination as to whether a sound indicated by the audio data is likely to be the hindrance to the driving operation, and configured to reduce, based on a result of the determination, a signal component that is included in the audio data and that is likely to be the hindrance to the driving operation.

This application is the U.S. National Phase under 35 U.S.C. § 371 of International Application No. PCT/JP 2023/035687, filed on Sep. 29, 2023, the entire contents of which is hereby incorporated by reference.

### TECHNICAL FIELD

The disclosure relates to an in-vehicle apparatus that is to be mounted on a vehicle and performs a process on audio data.

### BACKGROUND ART

A driver drives a vehicle while paying attention to, for example, a siren sound of an emergency vehicle. For example, Patent Literature 1 discloses a technique of determining whether an external sound includes an audio necessary for the driver, such as the siren sound of the emergency vehicle, and notifying the driver of an audio message or an image message when the external sound includes the audio necessary for the driver.

### CITATION LIST

### Patent Literature

Patent Literature 1: Japanese Unexamined Patent Application Publication No. 2003-004521

### SUMMARY OF INVENTION

An in-vehicle apparatus according to an aspect of the disclosure includes a storage circuit and a processing circuit. The storage circuit is configured to store pieces of reference audio data indicating sounds that are likely to be a hindrance to a driving operation of a driver. The processing circuit is configured to compare audio data included in a content with each of the pieces of reference audio data and perform a determination as to whether a sound indicated by the audio data is likely to be the hindrance to the driving operation, and configured to reduce, based on a result of the determination, a signal component that is included in the audio data and that is likely to be the hindrance to the driving operation.

### BRIEF DESCRIPTION OF DRAWINGS

The accompanying drawings are included to provide a further understanding of the disclosure, and are incorporated in and constitute a part of this specification. The drawings illustrate embodiments and, together with the specification, serve to explain the principles of the disclosure.

FIG. 1 is an explanatory diagram illustrating a configuration example of a vehicle on which an in-vehicle apparatus according to an embodiment of the disclosure is mounted.

FIG. 2 is a block diagram illustrating a configuration example of the in-vehicle apparatus illustrated in FIG. 1.

FIG. 3 is a flowchart illustrating an operation example of the in-vehicle apparatus illustrated in FIG. 2.

FIG. 4 is a block diagram illustrating a configuration example of an in-vehicle apparatus according to a modification example.

### MODES FOR CARRYING OUT THE INVENTION

In recent years, a vehicle is provided with a so-called infotainment system that provides information or entertainment to an occupant. In providing entertainment, various pieces of audio may be outputted from speakers inside the vehicle. Some of the pieces of audio included in such a content can likely to be a hindrance to a driver's driving operation, such as a siren sound of an emergency vehicle. Accordingly, it is expected that the driving operation of the driver be not hindered by the audio included in the content.

It is desirable to provide an in-vehicle apparatus that makes it possible to prevent a driving operation of a driver from being hindered.

In the following, some example embodiments of the disclosure are described in detail with reference to the accompanying drawings. Note that the following description is directed to illustrative examples of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiments which are not recited in a most-generic independent claim of the disclosure are optional and may be provided on an as-needed basis. The drawings are schematic and are not intended to be drawn to scale. Throughout the present specification and the drawings, elements having substantially the same function and configuration are denoted with the same reference numerals to avoid any redundant description. In addition, elements that are not directly related to any embodiment of the disclosure are unillustrated in the drawings.

### Embodiment

### Configuration Example

FIG. 1 illustrates a configuration example of a vehicle 1 including an in-vehicle apparatus according to an embodiment. The vehicle 1 may be a vehicle equipped with an advanced driver assistance system, or may be a vehicle that allows for achievement of automated driving. The vehicle 1 includes a steering wheel 2, a steering touch sensor 3, and an in-vehicle apparatus 10.

The steering wheel 2 is configured to steer the vehicle 1. The steering wheel 2 is to be held by a driver, and steers the vehicle 1 based on a steering operation performed by the driver.

The steering touch sensor 3 is provided on the steering wheel 2, and is configured to detect whether the driver holds the steering wheel 2.

The in-vehicle apparatus 10 is an infotainment system mounted on the vehicle 1.

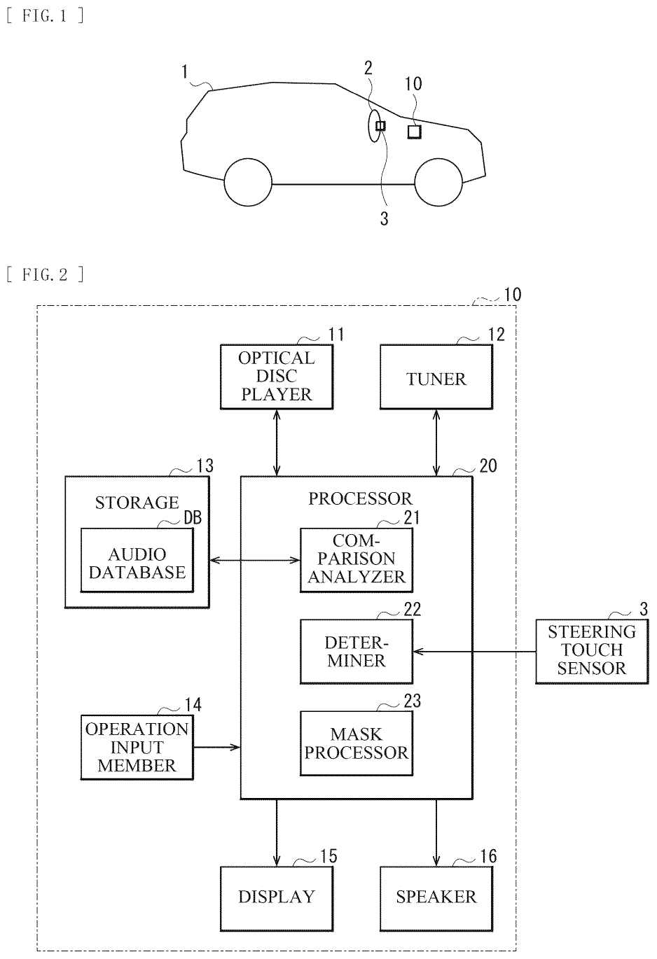

FIG. 2 illustrates a configuration example of the in-vehicle apparatus 10. The in-vehicle apparatus 10 includes an optical disc player 11, a tuner 12, a processor 20, a storage 13, an operation input member 14, a display 15, and a speaker 16.

The optical disc player 11 is configured to reproduce an audio content and a picture content by reproducing an optical disc such as CD (Compact Disc), DVD (Digital Versatile Disc), or BD (Blu-ray (registered trademark) Disc). The optical disc player 11 supplies data on the reproduced content to the processor 20.

The tuner 12 includes a device such as a radio tuner or a television tuner, and is configured to receive the audio content and picture content. The tuner 12 supplies data on the received content to the processor 20.

The processor 20 is configured to perform a process, based on the data supplied from the optical disc player 11 or the tuner 12. The processor 20 includes, for example, one or more processors and one or more memories, and is configured to perform the process by executing a program. The processor 20 includes a comparison analyzer 21, a determiner 22, and a mask processor 23.

The comparison analyzer 21 is configured to compare audio data included in the data supplied from the optical disc player 11 or the tuner 12 with pieces of audio data included in an audio database DB stored in the storage 13 and determine whether an audio included in the content is likely to be a hindrance to a driving operation of the driver. That is, when the content includes sounds including, for example, a siren sound of an emergency vehicle such as an ambulance or a horn sound of a vehicle, the driver can mistake that these sounds are actual sounds emitted from the surroundings of the vehicle 1, and can pay an excessive attention to the surroundings of the driving vehicle 1. In addition, when, for example, the content includes a warning sound of a vehicle equipped with an advanced driver assistance system, the driver can mistake that the sound is an actual sound emitted from the advanced driver assistance system of the vehicle 1, and the driver can erroneously perform a braking operation. As described above, the audio included in the content is likely to serve as a hinderance to the driving operation of the driver. Accordingly, the comparison analyzer 21 uses the audio database DB in which the pieces of audio data that are likely to be the hindrance to the driving operation of the driver are registered in advance, and determines whether the audio included in the content is likely to be the hindrance to the driving operation of the driver.

The determiner 22 is configured to determine whether the driver is willing to actively perform driving, based on a result of detection of the steering touch sensor 3. That is, for example, when the driver performs the driving operation of the vehicle 1, the driver holds the steering wheel 2; accordingly, the steering touch sensor 3 detects that the driver holds the steering wheel 2. When the vehicle 1 is stopped at a facility such as a parking lot, the driver releases his/her hands from the steering wheel 2; accordingly, the steering touch sensor 3 detects that the driver does not hold the steering wheel 2. In this way, the determiner 22 determines whether the driver is willing to actively perform the driving, based on the detection result of the steering touch sensor 3.

The mask processor 23 is configured to perform a mask process. The mask process reduces a signal component of the audio that is included in the data supplied from the optical disc player 11 or the tuner 12 and that is likely to be the hindrance to the driving operation of the driver.

The processor 20 also performs a predetermined process on picture data included in the data supplied from the optical disc player 11 or the tuner 12. The processor 20 supplies a picture signal corresponding to the processed picture data to the display 15, and supplies an audio signal corresponding to the processed audio data to the speaker 16.

The storage 13 is configured to store the audio database DB. The storage 13 includes, for example, a nonvolatile semiconductor memory. In the audio database DB, the various pieces of audio data that are likely to be the hindrance to the driving operation of the driver are registered in advance. The pieces of audio data included in the audio database DB include the audio data such as the siren sound of the emergency vehicle such as the ambulance, the horn sound of the vehicle, or the warning sound of the vehicle equipped with the advanced driver assistance system.

The operation input member 14 is configured to receive an operation of an occupant such as the driver, and includes, for example, a touch panel or various buttons. The occupant is able to perform, for example, a reproduction operation of the content in the optical disc player 11, a channel selection operation of the tuner 12, and an adjustment operation of the volume, using the operation input member 14.

The display 15 is configured to display various kinds of information on the vehicle 1 and a picture of the content, based on the picture signal supplied from the processor 20. The display 15 includes, for example, a liquid crystal display or an organic EL (Electro Luminescence) display.

The speaker 16 is configured to emit the audio of the content, based on the audio signal supplied from the processor 20.

Here, the storage 13 corresponds to a specific example of a “storage circuit” in one embodiment of the disclosure. The pieces of audio data registered in the audio database DB corresponds to a specific example of “pieces of reference audio data” in one embodiment of the disclosure. The processor 20 corresponds to a specific example of a “processing circuit” in one embodiment of the disclosure. The steering touch sensor 3 corresponds to a specific example of a “sensor” in one embodiment of the disclosure.

### Operation and Workings

Next, an operation and workings of the in-vehicle apparatus 10 according to the present embodiment will be described.

### Overview of Overall Operation

First, an operation of the in-vehicle apparatus 10 will be described with reference to FIGS. 1 and 2. The optical disc player 11 reproduces the audio content and the picture content. The tuner 12 receives the audio content and the picture content. The comparison analyzer 21 of the processor 20 compares the audio data included in the data supplied from the optical disc player 11 or the tuner 12 with the pieces of audio data included in the audio database DB stored in the storage 13 and determines whether the audio included in the content is likely to be the hindrance to the driving operation of the driver. The determiner 22 determines whether the driver is willing to actively perform the driving, based on the detection result of the steering touch sensor 3. The mask processor 23 performs the mask process that reduces the signal component of the audio that is included in the data supplied from the optical disc player 11 or the tuner 12 and that is likely to be the hindrance to the driving operation of the driver. The processor 20 also performs a predetermined process on the picture data included in the data supplied from the optical disc player 11 or the tuner 12. The processor 20 supplies the picture signal corresponding to the processed picture data to the display 15, and supplies the audio signal corresponding to the processed audio data to the speaker 16. The storage 13 stores the audio database DB. The operation input member 14 receives an operation of an occupant such as the driver. The display 15 displays various pieces of information on the vehicle 1 and a picture of the content, based on the picture signal supplied from the processor 20. The speaker 16 emits the audio of the content, based on the audio signal supplied from the processor 20.

### Detailed Operation

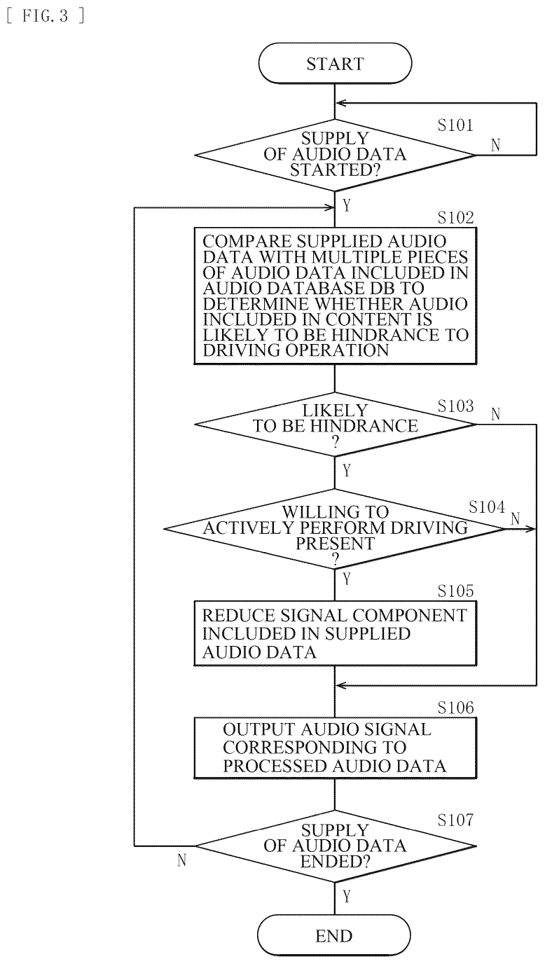

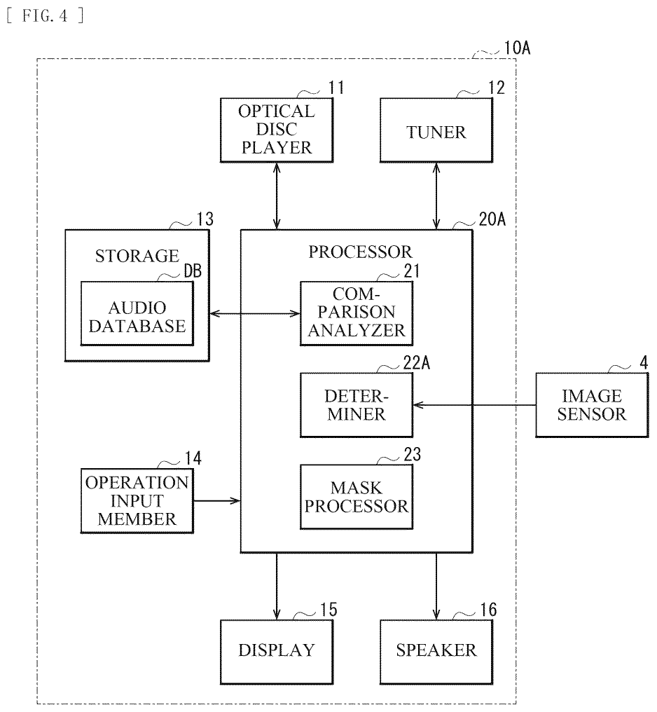

FIG. 3 illustrates a configuration example of the in-vehicle apparatus 10. When the in-vehicle apparatus 10 is powered on, the in-vehicle apparatus 10 performs the following operations.

First, the processor 20 of the in-vehicle apparatus 10 checks whether the supply of the audio data from the optical disc player 11 or the tuner 12 is started (step S101).

Next, the comparison analyzer 21 of the processor 20 compares the supplied audio data with the pieces of audio data included in the audio database DB and determines whether the audio included in the content is likely to be the hindrance to the driving operation of the driver (step S102). Specifically, the comparison analyzer 21 compares, for example, a main signal component included in the supplied audio data with signal components indicated by the pieces of audio data included in the audio database DB. For example, when the main signal component included in the supplied audio data coincide with or is similar to the signal components indicated by the pieces of audio data included in the audio database DB, the comparison analyzer 21 determines that the audio included in the content is likely to be the hindrance to the driving operation of the driver. That is, because the various pieces of audio data that are likely to be the hindrance to the driving operation of the driver are registered in the audio database DB, it is possible for the comparison analyzer 21 to determine whether the audio included in the content is likely to be the hindrance to the driving operation of the driver by using the audio database DB. When the audio included in the content is unlikely to be the hindrance to the driving operation of the driver (“N” in step S103), the process proceeds to step S106.

When the audio included in the content is likely to be the hindrance to the driving operation of the driver (“Y” in step S103), the determiner 22 of the processor 20 is configured to determine whether the driver is willing to actively perform the driving, based on the detection result of the steering touch sensor 3 (step S104). If there is no willing to actively perform the driving (“N” in step S104), the process proceeds to step S106.

When the driver is willing to actively perform the driving (“Y” in step S104), the mask processor 23 of the processor 20 reduces the signal component included in the supplied audio data (step S105). Specifically, for example, when the supplied audio data includes data on the siren sound of the emergency vehicle such as the ambulance, the mask processor 23 reduces the signal component of the siren sound.

The processor 20 outputs the audio signal corresponding to the processed audio data (step S106). The speaker 16 emits the audio of the content, based on the audio signal supplied from the processor 20.

The processor 20 checks whether the supply of the audio data from the optical disc player 11 or the tuner 12 is ended (step S107). When the supply of the audio data is not yet ended (“N” in step S107), the process returns to step S102, and the processor 20 repeats the processes from step S102 to S107 until the supply of the audio data is ended.

When the supply of the audio data from the optical disc player 11 or the tuner 12 is ended (“Y” in step S107), the process ends. Thereafter, the processor 20 starts the processes illustrated in FIG. 3. In this manner, the processor 20 performs the processes illustrated in FIG. 3 each time the audio data is supplied from the optical disc player 11 or the tuner 12.

As described above, the in-vehicle apparatus 10 includes: the storage circuit (the storage 13) configured to store the pieces of reference audio data (the pieces of audio data stored in the audio database DB) indicating sounds that are likely to be the hindrance to the driving operation of the driver; and the processing circuit (the processor 20) configured to compare the audio data included in the content with each of the pieces of reference audio data and perform the determination as to whether the sound indicated by the audio data is likely to be the hindrance to the driving operation, and configured to reduce, based on a result of the determination, the signal component that is included in the audio data and that is likely to be the hindrance to the driving operation. Thus, for example, when the audio included in the content is likely to be the hindrance to the driving operation of the driver, the in-vehicle apparatus 10 reduces the signal component of the audio, making it difficult for the sound that is likely to be the hindrance to reach the driver and to prevent the driving operation of the driver from being hindered.

In addition, in the in-vehicle apparatus 10, the processing circuit reduces the signal component that is included in the audio data and that is likely to be the hindrance to the driving operation. That is, the in-vehicle apparatus 10 does not reduce the signal component that is likely to be the hindrance to the driving operation by adding, for example, an anti-phase audio to the audio outputted from the speaker, but reduces the signal component that is likely to be the hindrance to the driving operation by data processing. Accordingly, because a processing accuracy is not affected by, for example, an ambient noise, it is possible for the in-vehicle apparatus 10 to improve the processing accuracy in reducing the signal component.

In addition, in the in-vehicle apparatus 10, the processing circuit (the processor 20) is configured to: perform, based on a result of the detection of the sensor (the steering touch sensor 3) configured to detect whether the driver performs the driving operation of the vehicle 1 provided with the in-vehicle apparatus 10, the determination as to whether the driver performs the driving operation of the vehicle 1; and configured to reduce the signal component included in the audio data, based on a result of the determination. Thus, for example, when the driver performs the driving operation of the vehicle 1, the processor 20 reduces the audio that is included in the content and that is likely to be the hindrance to the driving operation of the driver, making it possible to prevent the driving operation of the driver from being hindered. Further, for example, when the vehicle 1 is stopped at a facility such as a parking lot, the processor 20 does not reduce the audio; accordingly, the audio included in the content is prevented from being lost. Thus, it is possible for an occupant such as the driver to enjoy the content. Further, in the automated driving vehicle, the driver does not perform the driving operation of the vehicle 1 when the vehicle travels by automated driving; accordingly, the processor 20 does not reduce the audio that is likely to be the hindrance to the driving operation of the driver. Thus, it is possible for an occupant such as the driver to enjoy the content. As described above, the in-vehicle apparatus 10 reduces the audio that is likely to be the hindrance to the driving operation of the driver when the driver performs the driving operation of the vehicle 1, making it possible to effectively prevent the driving operation of the driver from being hindered.

In addition, in the in-vehicle apparatus 10, the sensor (the steering touch sensor 3) is provided on the steering wheel 2 of the vehicle 1, and is configured to detect whether the driver holds the steering wheel, and the processing circuit (the processor 20) is configured to determine that the driver performs the driving operation of the vehicle, based on the detection result of the sensor. Thus, it is possible for the in-vehicle apparatus 10 to determine whether the driver performs the driving operation of the vehicle by a simple method.

### Effects

In the present embodiment described above, provided are: the storage circuit configured to store the pieces of reference audio data indicating the sounds that are likely to be the hindrance to the driving operation of the driver; and the processing circuit configured to compare the audio data included in the content with each of the pieces of reference audio data and perform the determination as to whether the sound indicated by the audio data is likely to be the hindrance to the driving operation, and configured to reduce, based on a result of the determination, the signal component that is included in the audio data and that is likely to be the hindrance to the driving operation. Accordingly, it is possible to prevent the driving operation of the driver from being hindered.

In the present embodiment, the processing circuit is configured to: perform, based on a result of the detection of the sensor configured to detect whether the driver performs the driving operation of the vehicle provided with the in-vehicle apparatus, the determination as to whether the driver performs the driving operation of the vehicle; and reduce the signal component included in the audio data, based on a result of the determination. Accordingly, it is possible to effectively prevent the driving operation of the driver from being hindered.

In the present embodiment, the sensor is provided on the steering wheel of the vehicle, and is configured to detect whether the driver holds the steering wheel, and the processing circuit is configured to determine that the driver performs the driving operation of the vehicle, based on the result of the detection of the sensor. Thus, it is possible for the in-vehicle apparatus to determine whether the driver performs the driving operation of the vehicle by a simple method.

### Modification Examples

In the above-described embodiment, the steering touch sensor 3 is provided in the vehicle 1 as illustrated in FIG. 2, but it is not limited thereto. Alternatively, for example, the vehicle 1 may include an image sensor 4 configured to capture an image of the inside of the vehicle 1 as illustrated in FIG. 4. The vehicle 1 includes an in-vehicle apparatus 10A. The in-vehicle apparatus 10A includes a processor 20A having a determiner 22A. The determiner 22A is configured to determine whether the driver is willing to actively perform the driving by performing an image process, based on the captured image generated by the image sensor 4. Specifically, the determiner 22A may determine whether the driver is willing to actively perform the driving, based on a factor such as an attitude of the driver, an orientation of the driver's face, or whether the driver holds the steering wheel 2.

While some embodiments of the disclosure have been described by way of example with reference to the accompanying drawings, the disclosure is not limited to the above embodiments in any way. It will be understood by those skilled in the art that various changes and modifications can be made without departing from the scope defined by the appended claims. It is intended that the disclosure encompasses such modifications and variations as long as they fall within the scope of the appended claims and their equivalents.

For example, in the above-described embodiment, provided is the determiner 22, and when the determiner 22 determines that the driver is willing to actively perform the driving, the mask processor 23 reduces the signal component included in the supplied audio data, but it is not limited thereto. Alternatively, for example, the determiner 22 may not be provided. In this case, when the comparison analyzer 21 determines that the audio included in the content is likely to be the hindrance to the driving operation of the driver, the mask processor 23 reduces the signal component included in the supplied audio data.

The effects described in this specification are merely examples, and the effects of the disclosure are not limited to the effects described in this specification. Accordingly, the disclosure may achieve any other effect.

Further, the disclosure may take the following aspects.

(1)

An in-vehicle apparatus including:
a storage circuit configured to store pieces of reference audio data indicating sounds that are likely to be a hindrance to a driving operation of a driver; and
a processing circuit configured to compare audio data included in a content with each of the pieces of reference audio data and perform a determination as to whether a sound indicated by the audio data is likely to be the hindrance to the driving operation, and configured to reduce, based on a result of the determination, a signal component that is included in the audio data and that is likely to be the hindrance to the driving operation.
   (2)

The in-vehicle apparatus according to (1), in which the processing circuit is configured to: perform, based on a result of detection of a sensor configured to detect whether the driver performs the driving operation of a vehicle provided with the in-vehicle apparatus, a determination as to whether the driver performs the driving operation of the vehicle; and reduce the signal component included in the audio data, based on a result of the determination.

(3)

The in-vehicle apparatus according to (2), in which
the sensor is provided on a steering wheel of the vehicle, and is configured to detect whether the driver holds the steering wheel, and
the processing circuit is configured to determine that the driver performs the driving operation of the vehicle, based on the result of the detection of the sensor.
   (4)

The in-vehicle apparatus according to any one of (1) to (3), in which the processing circuit is configured to supply, to a speaker, an audio signal corresponding to the audio data in which the signal component is reduced.

The processor 20 illustrated in FIG. 2 is implementable by circuitry including at least one semiconductor integrated circuit such as at least one processor (e.g., a central processor (CPU)), at least one application specific integrated circuit (ASIC), and/or at least one field programmable gate array (FPGA). At least one processor is configurable, by reading instructions from at least one machine readable non-transitory tangible medium, to perform all or a part of functions of the processor 20 illustrated in FIG. 2. Such a medium may take many forms, including, but not limited to, any type of magnetic medium such as a hard disk, any type of optical medium such as a CD and a DVD, any type of semiconductor memory (i.e., semiconductor circuit) such as a volatile memory and a non-volatile memory. The volatile memory may include a DRAM and a SRAM, and the nonvolatile memory may include a ROM and a NVRAM. The ASIC is an integrated circuit (IC) customized to perform, and the FPGA is an integrated circuit designed to be configured after manufacturing in order to perform, all or a part of the functions of the processor 20 illustrated in FIG. 2.

1. An in-vehicle apparatus comprising:
a storage circuit configured to store pieces of reference audio data indicating sounds that are likely to be a hindrance to a driving operation of a driver; and
a processing circuit configured to compare audio data comprised in a content with each of the pieces of reference audio data and perform a determination as to whether a sound indicated by the audio data is likely to be the hindrance to the driving operation, and configured to reduce, based on a result of the determination, a signal component that is comprised in the audio data and that is likely to be the hindrance to the driving operation.

2. The in-vehicle apparatus according to claim 1, wherein the processing circuit is configured to: perform, based on a result of detection of a sensor configured to detect whether the driver performs the driving operation of a vehicle provided with the in-vehicle apparatus, a determination as to whether the driver performs the driving operation of the vehicle; and reduce the signal component comprised in the audio data, based on a result of the determination.

3. The in-vehicle apparatus according to claim 2, wherein
the sensor is provided on a steering wheel of the vehicle, and is configured to detect whether the driver holds the steering wheel, and
the processing circuit is configured to determine that the driver performs the driving operation of the vehicle, based on the result of the detection of the sensor.

4. The in-vehicle apparatus according to claim 1, wherein the processing circuit is configured to supply, to a speaker, an audio signal corresponding to the audio data in which the signal component is reduced.
